(19) United States
(12) Patent Application Publication
(10) Pub. No.: US 2025/0074661 A1
(43) Pub. Date: Mar. 6, 2025

(54) Sealing Plug

(71) Applicant: Illinois Tool Works Inc., Glenview, IL (US)

(72) Inventors: Zhilin LI, Shanghai (CN); Jiahui HE, Shanghai (CN)

(21) Appl. No.: 18/823,834

(22) Filed: Sep. 4, 2024

(30) Foreign Application Priority Data
Sep. 5, 2023 (CN) 202311139607.3
Aug. 21, 2024 (CN) 202411156538.1

(51) Int. Cl. B65D 39/00

(52) U.S. Cl. CPC B65D 39/0052

(57) ABSTRACT

The present disclosure discloses a sealing plug, comprising a sealing cover, a sealant and a bracket. The sealing cover is connected to the bracket to sandwich the sealant between the sealing cover and the bracket, and the sealant is at least partially received in a receiving space of the sealing cover. In the sealing plug of the present disclosure, the sealing cover and the bracket are two separate parts, and are then connected together by a connection process such as riveting, and the sealant can be sandwiched between the sealing cover and the bracket. In addition, the sealing plug can restrict the flow of the sealant when the sealant melts, thus avoiding sagging of the sealant after melting or unevenness of the sealant after curing, which not only does not affect the appearance of the component to be sealed, but also ensures the reliability of the sealing plug for sealing the hole of the component to be sealed. In addition, in the sealing plug of the present disclosure, it is only necessary to connect the sealing cover and the bracket both made of metal, which avoids the connection between the sealant that is soft and a metal part, thereby reducing the assembly difficulty of the sealant.

### RELATED APPLICATIONS

The present application claims the benefit of Chinese Patent Application Nos. 202311139607.3, filed Sep. 5, 2023, and 202411156538.1, filed Aug. 21, 2024, each titled “Sealing Plug,” the contents of which are hereby incorporated by reference.

### TECHNICAL FIELD

The present disclosure relates to a sealing plug, and in particular to a sealing plug for sealing a hole in a component to be sealed.

### BACKGROUND

During manufacturing of a body of a vehicle, holes are formed in a panel of a body structure and need to be sealed to prevent dust or water from entering. Sealing plugs are used to be inserted into the holes and form seals with the panel to be sealed. In some vehicles that use batteries as driving energy sources, the sealing plugs also need to be flame retardant.

### SUMMARY

The present disclosure generally relates to a sealing plug, substantially as illustrated by and described in connection with at least one of the figures, as set forth more completely in the claims. In some examples, the present disclosure relates generally to a sealing plug for sealing a hole of a component to be sealed.

### DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1A is a perspective view of a sealing plug according to an embodiment of the present disclosure from one perspective.

FIG. 1B is a perspective view of the sealing plug shown in FIG. 1A from another perspective.

FIG. 1C is an exploded view of the sealing plug shown in FIG. 1A.

FIG. 1D is an axial cross-sectional view of the sealing plug shown in FIG. 1A.

FIG. 2A is a top view of a sealing cover shown in FIG. 1A.

FIG. 2B is an axial cross-sectional view of the sealing cover shown in FIG. 2A along line A-A.

FIG. 3A is a perspective view of a sealant shown in FIG. 1A.

FIG. 3B is an axial cross-sectional view of the sealant shown in FIG. 3A.

FIG. 4A is a perspective view of a bracket shown in FIG. 1A.

FIG. 4B is a side view of the bracket shown in FIG. 4A.

FIGS. 5A to 5D show a process of inserting the sealing plug shown in FIG. 1A into a hole in a component to be sealed.

FIG. 6A is a perspective view of a sealing plug according to another embodiment of the present disclosure from one perspective.

FIG. 6B is a perspective view of the sealing plug shown in FIG. 6A from another perspective.

FIG. 7 is a perspective view of a bracket shown in FIG. 6A.

### DETAILED DESCRIPTION

Various specific embodiments of the present disclosure will be described below with reference to the drawings which constitute part of the present disclosure. It should be understood that although the terms for indicating orientations, such as “front”, “rear”, “upper”, “lower”, “left”, “right”, “top”, “bottom”, “inner” and “outer”, are used in the present disclosure to describe various illustrative structural parts and elements in the present disclosure, these terms used herein are only for ease of description and are determined based on the illustrative orientations shown in the drawings. Since the embodiments disclosed in the present disclosure may be arranged in different directions, these terms indicating orientations are only illustrative and should not be considered as limitations.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The present disclosure provides a sealing plug for sealing a hole of a component to be sealed, the sealing plug including a sealing cover, a sealant and a bracket. The sealing cover is configured to cover the hole of the component to be sealed and has at least one receiving space. The sealant is disposed around the hole of the component to be sealed and is at least partially received in the receiving space. The bracket is connected to the sealing cover. The sealing cover and the bracket are configured such that when the sealant melts, the sealing cover and the bracket at least partially restrict the flow of the sealant.

In the sealing plug as described above, the at least one receiving space includes a receiving groove, wherein the receiving groove extends from the bottom of the sealing cover towards the top of the sealing cover, the receiving groove forms a bottom opening at the bottom of the sealing cover, and the sealant is at least partially received in the receiving groove through the bottom opening. The bracket is connected below the sealing cover and at least partially shields the bottom opening, such that the sealant is sandwiched between the sealing cover and the bracket.

In the sealing plug as described above, the sealing plug has an axis, the receiving groove extends from the bottom of the sealing cover towards the top of the sealing cover in the direction of the axis, and the receiving groove and the sealant are ring-shaped extending around the axis.

In the sealing plug as described above, the sealant includes a sealing top portion and a sealing bottom portion. The sealing top portion is received in the receiving groove. The sealing bottom portion is connected to the sealing top portion, and the sealing bottom portion is disposed around the hole of the component to be sealed.

In the sealing plug as described above, the sealing cover includes a sealing lip and an arched portion. The arched portion arches upwards relative to the sealing lip, the sealing lip is disposed around the arched portion and at the periphery of the arched portion, and the receiving groove is disposed in the arched portion. The sealing bottom portion is connected below the sealing lip and is configured to abut against the component to be sealed.

In the sealing plug as described above, the sealing cover further includes a cover body, the arched portion is disposed around the cover body and between the cover body and the sealing lip, and the bracket is connected to the cover body.

In the sealing plug as described above, the sealant includes a sealant body, the sealing top portion extends inwards from the top of the sealant body, and the sealing bottom portion extends outwards from the bottom of the sealant body.

In the sealing plug as described above, the bracket is configured such that when the sealing plug seals the hole of the component to be sealed, the bracket is snap-fitted with a hole edge of the hole of the component to be sealed to retain the sealing plug in the component to be sealed.

In the sealing plug as described above, the bracket includes at least two clips, each of which extends downwards from an edge of the bracket, and each of which includes a resilient leg configured to be resiliently deflected to abut against the hole edge of the hole to retain the sealing plug in the component to be sealed.

In the sealing plug as described above, each of the clips has a window. The resilient leg includes an upper leg portion, a bent portion and a lower leg portion, the bent portion being connected between the upper leg portion and the lower leg portion, the upper leg portion extending obliquely outwards from a top end of the leg portion to the bent portion, and the lower leg portion extending obliquely inwards from the bent portion to a bottom end of the lower leg portion. The bottom end of the lower leg portion is connected to an edge of the window, and the top end of the upper leg portion forms a free end.

In the sealing plug as described above, the resilient leg further includes a top portion, wherein the top portion is connected to the top of the upper leg portion, and the top portion is disposed at an inner side of the sealing bottom portion of the sealant.

In the sealing plug as described above, the sealing cover and the bracket are made of metal material, and the sealant is made of hot melt adhesive.

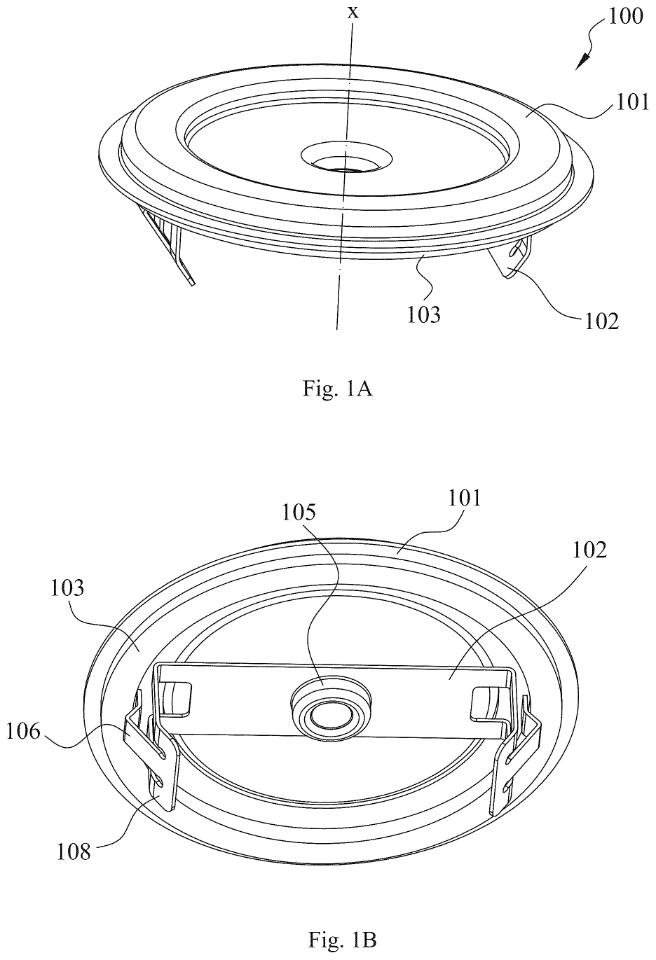

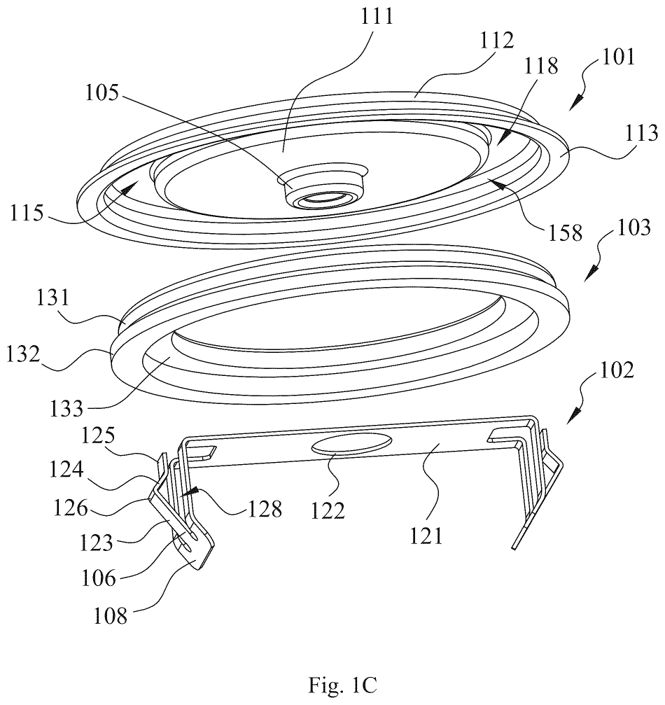

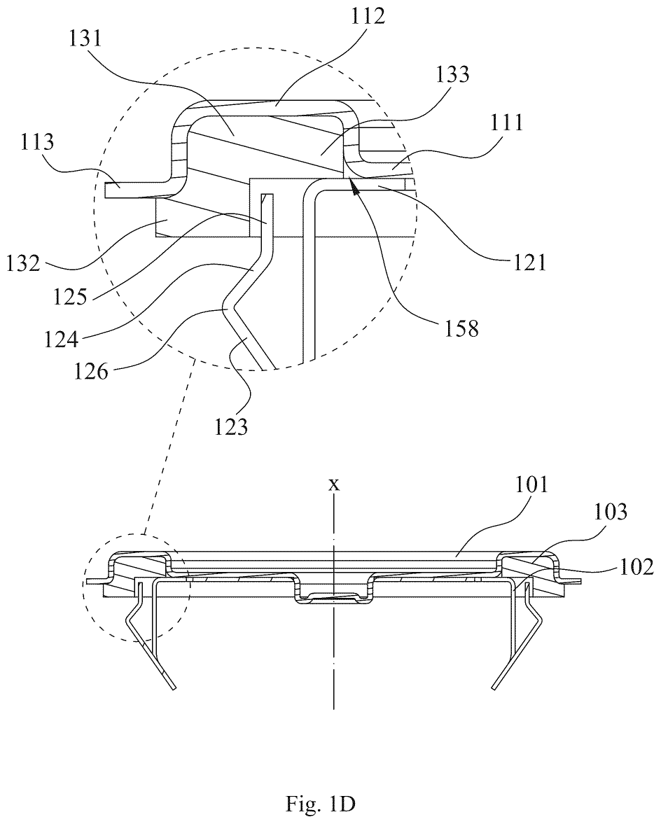

FIGS. 1A to 1D are structural schematic diagrams of a sealing plug 100 according to the present disclosure, showing a general structure of the sealing plug 100. FIG. 1A shows a perspective view of the sealing plug 100 as viewed from above, FIG. 1B shows a perspective view of the sealing plug 100 as viewed from below, FIG. 1C shows an exploded view of the sealing plug 100, and FIG. 1D shows an axial cross-sectional view of the sealing plug 100. As shown in FIGS. 1A to 1D, the sealing plug 100 is generally in an axially symmetric shape and has an axis x. For ease of description below, a direction along the axis x is defined as an axial direction of the sealing plug 100, a direction around the axis x is defined as a circumferential direction of the sealing plug 100, and a direction perpendicular to the axis x is defined as a radial direction of the sealing plug 100.

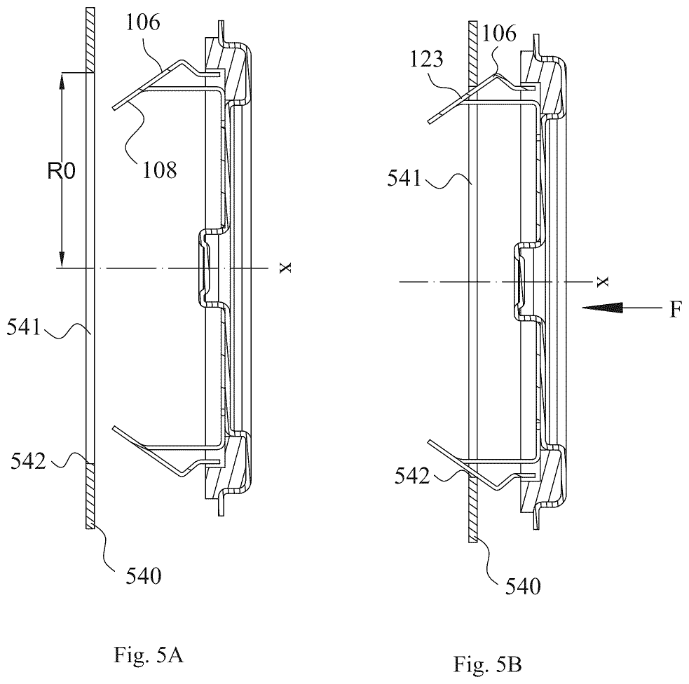

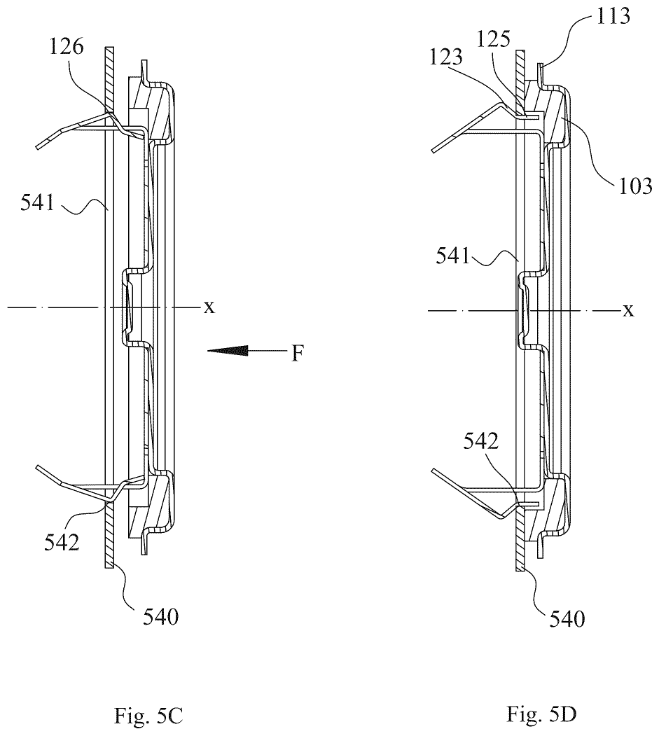

As shown in FIGS. 1A to 1D, the sealing plug 100 includes a sealing cover 101, a sealant 103 and a bracket 102. The sealing cover 101 has at least one receiving space 118, and the sealant 103 is at least partially received in the receiving space 118. The sealing cover 101 is connected to the bracket 102 to form the sealing plug 100. In this embodiment, the sealant 103 is clamped or sandwiched between the sealing cover 101 and the bracket 102, and the sealing cover 101 and the bracket 102 are made of metal material and thus have strong heat resistance. The sealant 103 is made of hot melt adhesive having a lower melting point than the metal material, such that the sealant 103 can melt at a high temperature and cure at a low temperature. The sealing cover 101 is generally in the shape of a circular plate, and is sized to cover a hole 541 in a component to be sealed 540. Thus, when the sealing plug 100 is used to seal the hole 541 in the component to be sealed 540, the sealant 103 is first heated to melt, and is then cooled to cure and adhere to the component to be sealed 540, such that the sealing plug 100 is connected to the component to be sealed 540 in a sealing manner (see FIGS. 5A to 5C). In the present disclosure, the sealing cover 101 and the bracket 102 are configured such that when the sealant 103 melts, the sealing cover 101 and the bracket 102 at least partially restrict the flow of the sealant 103.

Specifically, the at least one receiving space 118 includes a receiving groove 115, and the receiving groove 115 extends from the bottom of the sealing cover 101 towards the top thereof and forms a bottom opening 158 at the bottom of the sealing cover 101. The sealant 103 is at least partially received in the receiving groove 115 through the bottom opening 158. In this embodiment, the receiving groove 115 axially extends from the bottom of the sealing cover 101 towards the top thereof, and is configured as an annular groove around the axis x. The sealing cover 101 includes a cover body 111, an arched portion 112 and a sealing lip 113. The arched portion 112 is disposed around the cover body 111 and between the cover body 111 and the sealing lip 113. In this embodiment, the arched portion 112 is arched upwards relative to the cover body 111 and the sealing lip 113, such that the receiving groove 115 is disposed at the bottom of the arched portion 112. In other embodiments, the receiving groove 115 may also be configured as a plurality of discontinuous receiving grooves disposed around the cover body 111 and at the bottom of the arched portion 112. The receiving groove 115 is configured to receive at least a portion of the sealant 103 to at least partially restrict the flow of the sealant 103 when the sealant 103 melts.

The sealing lip 113 is disposed around the arched portion 112 and at the periphery of the arched portion 112. The sealing lip 113 radially extends outwards from the bottom of a peripheral wall of the arched portion 112. The sealing lip 113 is shaped and sized to be disposed around the hole 541 of the component to be sealed 540. A portion of the sealant 103 is disposed below the sealing lip 113, such that the sealing lip 113 can be connected to the component to be sealed 540 in a sealing manner by means of the sealant 103. The sealing plug 100 and the component to be sealed 540 can be connected together through the connection between the sealing lip 113 and the component to be sealed 540 in a sealing manner.

The cover body 111 includes a positioning post 105 located at the middle of the cover body 111, and the positioning post 105 extends downwards from the bottom of the cover body 111. The positioning post 105 is configured to be connected to the bracket 102. In this embodiment, the bracket 102 is provided with a positioning hole 122 at a corresponding position. The positioning post 105 can be inserted into the positioning hole 122, and then the positioning post 105 and the bracket 102 are riveted together by a press riveting process. FIGS. 1A to 1D only show a state in which the positioning post 105 is inserted into the positioning hole 122, but do not show a state in which the positioning post 105 is riveted to the bracket 102. In some embodiments, the positioning post 105 may be connected to the bracket 102 by other connection methods. In some embodiments, the cover body 111 may not include the positioning post 105, and the cover body 111 may be connected to the bracket 102 by other connection methods.

The bracket 102 is connected below the sealing cover 101 and at least partially shields the bottom opening 158 of the receiving groove 115, such that the sealant 103 is sandwiched between the sealing cover 101 and the bracket 102. The bracket 102 includes at least two resilient legs 106. The resilient legs 106 are resilient, and can move toward the axis x or away from the axis x. When the sealing plug 100 is connected to the component to be sealed 540 in a sealing manner, the resilient legs 106 of the bracket 102 can abut against a hole edge 542 of the hole 541 of the component to be sealed 540, thereby preventing the sealing plug 100 from unexpectedly disengaging from the component to be sealed 540. Specifically, the bracket 102 includes a connecting beam 121, and the positioning hole 122 is disposed at the center of the connecting beam 121. In this embodiment, the connecting beam 121 is in the shape of a radially extending cross bar, the bracket 102 includes two clips 108, and the clips 108 respectively extend downwards from opposite ends of the connecting beam 121. Each clip 108 has a resilient leg 106. One end of the resilient leg 106 is connected to the clip 108, and the other end of the resilient leg 106 is suspended, such that the resilient leg 106 can be resilient to move toward or away from the axis x. In this embodiment, each clip 108 is provided with a window 128 that extends downwards from the connecting beam 121 to the lower portion of the clip 108 but does not penetrate the clip 108. A bottom end of the resilient leg 106 is connected to a bottom edge of the window 128, and a top end of the resilient leg 106 is suspended to form a free end. The resilient leg 106 sequentially includes, from bottom to top, a lower leg portion 123, an upper leg portion 124 and a top portion 125. In the direction from bottom to top, the lower leg portion 123 extends obliquely away from the axis x, the upper leg portion 124 extends obliquely close to the axis x, and the top portion 125 extends vertically along the axis x. The upper leg portion 124 and the lower leg portion 123 form an outwardly protruding inflection point or bent portion 126 at the connection. That is, the resilient leg 106 has the largest distance from the axis x at the bent portion 126.

Thus, during the process of inserting the sealing plug 100 into the hole 541 from top to bottom, the resilient leg 106 can be first inserted downwards into the hole 541, then the resilient leg 106 is pressed by the hole edge 542 of the hole 541 to elastically deform toward the axis x, and finally after crossing the bent portion 126, the resilient leg 106 restores to abut against the hole edge 542.

It is to be understood by those skilled in the art that the resilient leg 106 on the bracket 102 of the present disclosure is not limited to the structures described in this embodiment, and that the resilient leg 106 may also be in other shapes and structures, as long as the resilient leg 106 is capable of elastically deforming when subjected to an inward radial pressing force. For example, the top portion of the resilient leg 106 may be connected to the connecting beam 121, and the bottom end of the resilient leg 106 forms a free end.

The sealant 103 is circular ring-shaped, and includes a sealing top portion 133 and a sealing bottom portion 132. In this embodiment, the sealing top portion 133 is received in the receiving groove 115. The sealing bottom portion 132 is connected below the sealing top portion 133, and the sealing bottom portion 132 is disposed below the sealing lip 113 and disposed around the hole 541 of the component to be sealed 540. As an example, the sealant 103 includes a sealant body 131, the sealing top portion 133 radially extends inwards from the top of the sealant body 131, and the sealing bottom portion 132 radially extends outwards from the bottom of the sealant body 131. A lower surface of the sealing top portion 133 can abut against the top of the bracket 102 (for example, the top of the connecting beam 121 of the bracket), such that the sealant 103 can be sandwiched between the sealing cover 101 and the bracket 102 when the bracket 102 is connected to the sealing cover 101. When the sealing top portion 133 is received in the receiving groove 115, the sealing bottom portion 132 is located below the sealing lip 113, such that the sealing bottom portion 132 is configured to be sandwiched between the sealing cover 101 and the component to be sealed 540 when the sealing plug 100 is mounted into the hole 541.

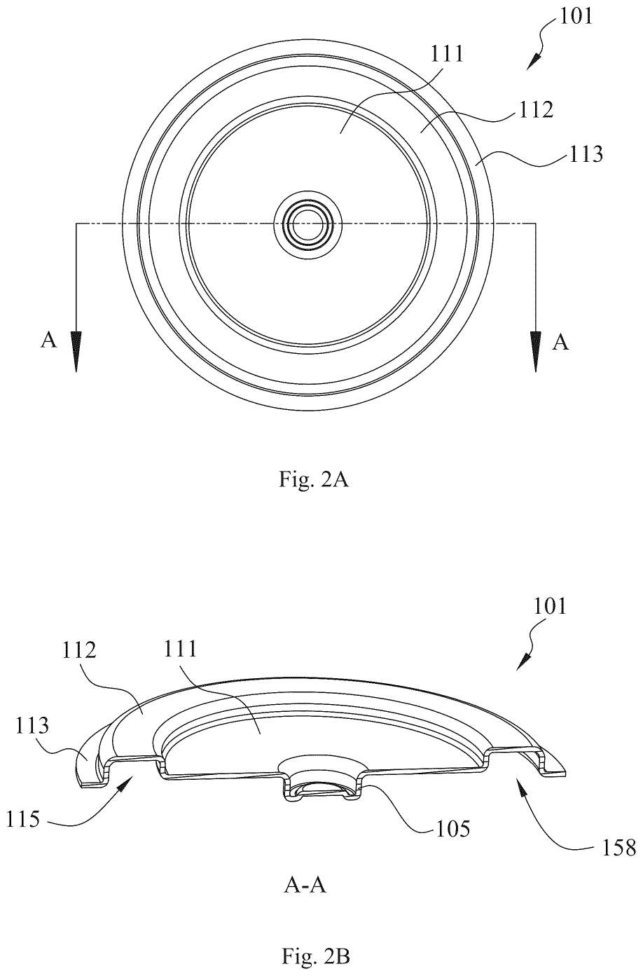

FIGS. 2A and 2B show a specific structure of the sealing cover 101. FIG. 2A is a top view of the sealing cover 101, and FIG. 2B is an axial cross-sectional view of the sealing cover 101 along line A-A. As shown in FIGS. 2A and 2B, the sealing cover 101 is made of a metal material. For ease of machining, the arched portion 112 and the receiving groove 115 are formed by stamping upwards from the bottom at the position of an outer rim of the cover body 111, and the positioning post 105 is formed by stamping downwards from the top at the position of the center of the cover body 111. A lower surface of the cover body 111 is configured to abut against an upper surface of the bracket 102, and a lower surface of the sealing lip 113 is configured to abut against the sealing bottom portion 132 of the sealant 103.

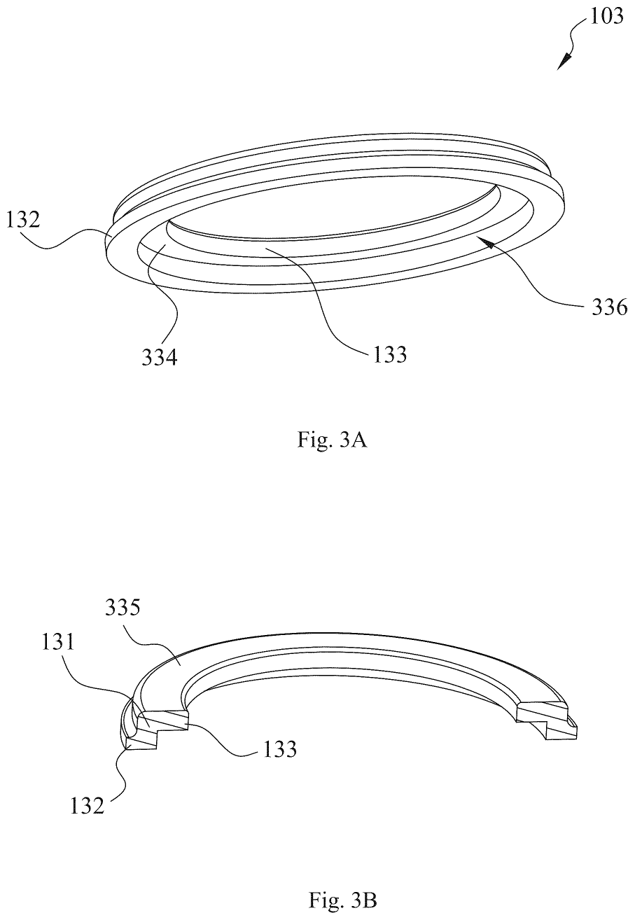

FIGS. 3A and 3B show a specific structure of the sealant 103. FIG. 3A is a perspective view of the sealant 103 as viewed from below, and FIG. 3B is an axial cross-sectional view of the sealant 103. As shown in FIGS. 3A and 3B, the sealant 103 is made of hot melt adhesive by an injection molding process.

The sealing top portion 133 of the sealant 103 radially protrudes inwards from the top of the sealant body 131, such that an annular gap 336 is formed between the sealing top portion 133 and the sealing bottom portion 132. A lower surface 334 of the sealing top portion 133 can at least partially touch the connecting beam 121 of the bracket 102, and the annular gap 336 can receive the top portion 125 of the resilient leg 106.

The sealing bottom portion 132 of the sealant 103 radially protrudes outwards from the bottom of the adhesive body 131, such that the sealant 103 is shaped to match the sealing cover 101. An upper surface of the sealing bottom portion 132 closely fits with a lower surface of the sealing lip 113. A lower surface of the sealing bottom portion 132 is configured to closely fit with an upper surface of the component to be sealed 540.

When the sealing plug 100 in a vertical state is heated, the receiving groove 115 can restrict the flow of a top portion 335 of the sealant 103 in the radial direction because the sealing top portion 133 of the sealant 103 is received in the receiving groove 115. Although the sealing bottom portion 132 is not received in the receiving groove 115, it is sandwiched between the sealing lip 113 and the component to be sealed 540 in the axial direction, and is restricted by the top portion 125 of the resilient leg 106 in the radial direction, thus having a limited flow range. Thus, the sealing plug 100 of the present disclosure can reduce the risk of sagging of the sealant 103, thereby ensuring that the sealant 103 can be evenly disposed in the circumferential direction and thus ensuring the sealing effect of the sealing plug 100.

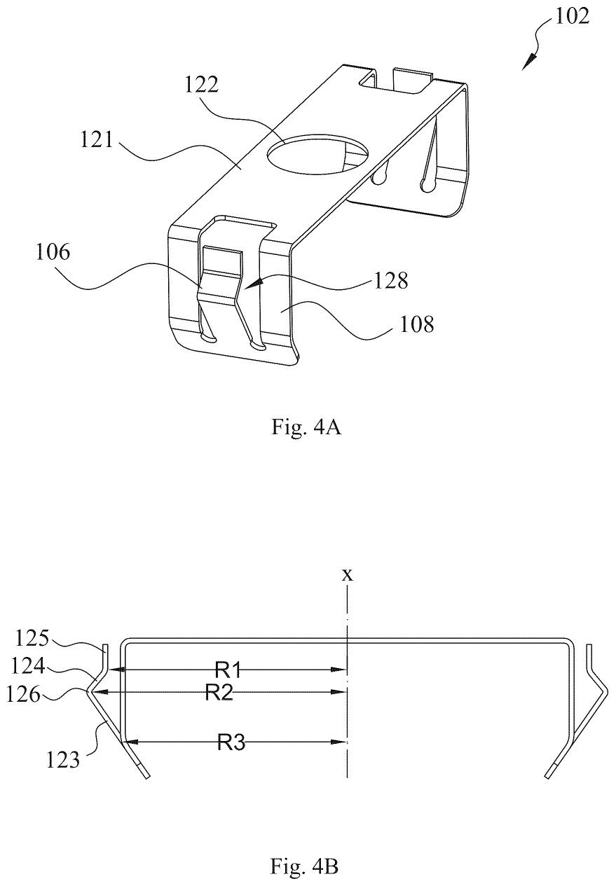

FIGS. 4A and 4B show a specific structure of the bracket 102. FIG. 4A shows a perspective view of the bracket, and FIG. 4B shows a side view of the bracket. As shown in FIGS. 4A and 4B, the resilient leg 106 and the window 128 are formed by cutting from the clip 108 and are bent by a bending process. The bottom portion of the clip 108 is bent toward the axis x to facilitate insertion of the clip 108 into the hole 541 of the component to be sealed 540.

A distance R3 between the bottom of the lower leg portion 123 of the resilient leg 106 and the axis x is designed to be smaller than the radius R0 of the hole 541 in the component to be sealed 540. A distance R2 between the bent portion 126 of the resilient leg 106 and the axis x is designed to be larger than the radius R0 of the hole 541 in the component to be sealed 540. A distance R1 between the top portion 125 of the resilient leg 106 and the axis x is designed to be substantially equal to or slightly larger than the radius R0 of the hole 541 in the component to be sealed 540. By providing the resilient legs 106 that can be elastically deformed toward the axis x or restored away from the axis x, the sealing plug 100 can be inserted into and retained in the hole 541 of the component to be sealed 540.

In this embodiment, the length and inclination angle of the lower leg portion 123 in the axial direction can be designed based on the radius R0 of the hole 541 and the required insertion force. The lengths of the upper leg portion 124 and the top portion 125 in the axial direction and the inclination angle of the upper leg portion 124 can be designed based on the thickness of the component to be sealed 540 and the thickness of the sealant 103, such that the hole edge 542 of the hole 541 abuts against the connection between the top portion 125 and the upper leg portion 124 when the lower surface of the sealant 103 abuts against the upper surface of the component to be sealed 540.

FIGS. 5A to 5D show positions of the sealing plug 100 relative to the component to be sealed 540 during the process of inserting the sealing plug 100 into the hole 541 of the component to be sealed 540.

As shown in FIG. 5A, the sealing plug 100 is aligned with the hole 541 of the component to be sealed 540, but has not yet been inserted into the hole 541. Since the distance R3 between the bottom of the lower leg portion 123 of the resilient leg 106 and the axis x is smaller than the radius R0 of the hole 541, and the bottom of the clip 108 is further bent toward the axis x, the bottom of the clip 108 and the bottom of the resilient leg 106 can be inserted to the left into the hole 541.

As shown in FIG. 5B, the sealing plug 100 has just been inserted into the hole 541, but the resilient leg 106 has not yet been elastically deformed. Since the lower leg portion 123 extends obliquely outwards away from the axis x from left to right (i.e., from bottom to top in FIG. 4B), the lower leg portion 123 can be inserted into the hole 541 until an outer surface of the lower leg portion 123 abuts against the hole edge 542 of the hole 541. At this point, a left surface of the sealant 103 has not yet abutted against a right surface of the component to be sealed 540. An operator applies a leftward force F from the top of the sealing plug 100, forcing the sealing plug 100 to continue to move to the left. The lower leg portion 123 is pressed by the hole edge 542 to elastically deform inwards, forcing both resilient legs 106 to elastically deform inwards. The distance between the lower leg portions 123 of the two resilient legs 106 is reduced, such that the resilient legs 106 can continue to be inserted to the left into the hole 541 until they reach the position as shown in FIG. 5C.

As shown in FIG. 5C, the inflection points 126 of the resilient legs 106 abut against the hole edge 542 of the hole 541, and the resilient legs 106 elastically deform until they reach the position closest to the axis x. At this point, the left surface of the sealant 103 has not yet abutted against the right surface of the component to be sealed 540. The operator can continue to apply the leftward force F from the top of the sealing plug 100, forcing the sealing plug 100 to continue to move to the left. After the inflection points 126 cross the hole edge 542 of the hole 541, the resilient legs 106 are no longer pressed by the hole edge 542 and move outwards to restore until they reach the position as shown in FIG. 5D.

As shown in FIG. 5D, outer surfaces of the top portions 125 of the resilient legs 106 abut against the hole edge 542 of the hole 541, and the resilient legs 106 undergo no elastic deformation or a small amount of elastic deformation, such that the top portions 125 tightly abut against the hole edge 542. At this point, the left surface of the sealant 103 abuts against the right surface of the component to be sealed 540, and the sealing plug 100 cannot continue to move to the left. The right surface of the sealant 103 abuts against the sealing lip 113 of the sealing plug 100. The bottom of the hole edge 542 abuts against the connection between the top portion 125 and the upper leg portion 124 to prevent the sealing plug 100 from unexpectedly disengaging to the right.

After the sealing plug 100 is mounted to the component to be sealed 540, the component to be sealed 540 may be heated as a whole for a period of time to melt the sealant 103. At this point, since most of the top of the sealant 103 is received in the receiving groove 115, the sealant 103 will hardly sag regardless of whether the component to be sealed 540 is placed horizontally or vertically. The sealant 103 is then cooled to cure, such that the sealing plug 100 can be connected to the component to be sealed 540 in a sealing manner by means of the sealant 103.

Before the sealant 103 melts, the operator may also pull the sealing plug 100 out of the hole 541 of the component to be sealed 540. The operation process is as shown in FIGS. 5D to 5A. The hole edge 542 of the hole 541 abuts against the upper leg portions 123 of the resilient legs 106 and moves along the upper leg portions 123 to force the resilient legs 106 to elastically deform inwards. The sealing plug 100 can be pulled out after the sealing plug 100 is moved to the right until the bent portion 126 crosses the hole edge 542 of the hole 541.

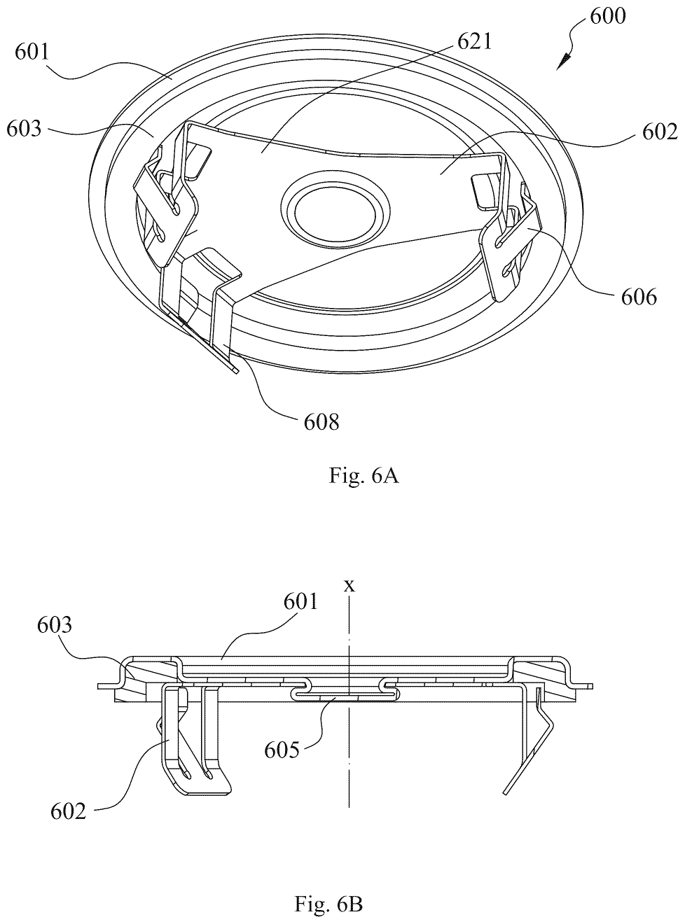

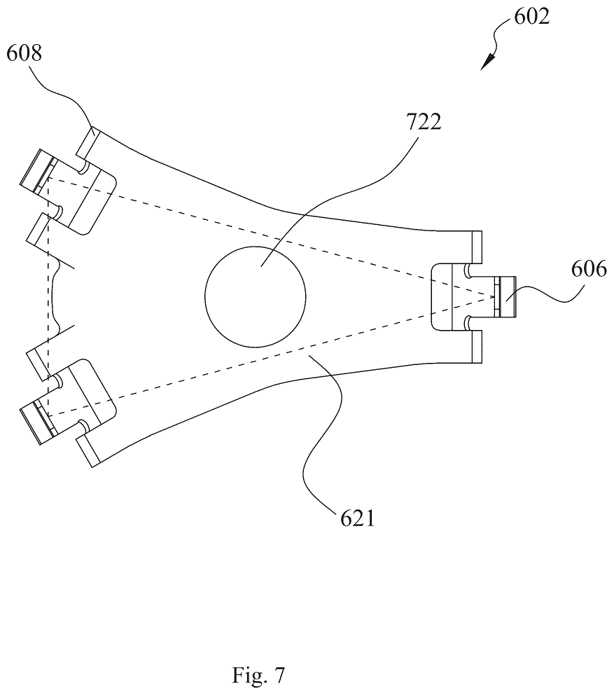

FIGS. 6A and 6B show a specific structure of the sealing plug 600 according to another embodiment of the present disclosure. FIG. 6A shows a perspective view of the sealing plug 600 as viewed from below, and FIG. 6B shows an axial cross-sectional view of the sealing plug 600. The structure of the sealing plug 600 is substantially the same as the structure of the sealing plug 100. The sealing plug 600 includes a sealing cover 601, a sealant 603 and a bracket 602. The sealing cover 601 and the sealant 603 have the same structure as the sealing cover 101 and the sealant 103. However, the structure of the bracket 602 is different from the structure of the bracket 102. In this embodiment, the bracket 602 includes three clips 608. Each clip 608 includes a resilient leg 606, that is, the bracket 602 includes three resilient legs 606. The three clips 608 are disposed around an axis x and at an end portion of a connecting beam 621. The specific structure of the bracket 602 will be described in detail with reference to FIG. 7.

FIGS. 6A and 6B show a state in which a positioning post 605 is riveted to the bracket 602. After the positioning post 605 is inserted into a positioning hole 722 of the bracket 602 (see FIG. 7), the positioning post and the bracket may be riveted together by a press riveting process. After the riveting is completed, the outer diameter of the positioning post 605 is greater than the diameter of the positioning hole 722, such that the sealing cover 601 and the bracket 602 can be connected together.

FIG. 7 shows a top view of the bracket 602 to illustrate a specific structure of the bracket 602. As shown in FIG. 7, the three clips 608 of the bracket 602 are in a triangular arrangement around the axis x. The resilient leg 606 of each clip 608 has the same structure as the resilient leg 601. A bottom end of the resilient leg 606 is connected to the bottom of the clip 608, and a top end thereof forms a free end, such that the resilient leg 606 can elastically deform toward the axis x or restore away from the axis x. Compared to the bracket 102, the three clips 608 in a triangular arrangement are more structurally stable than the arrangement of a pair of clips 108. When the operator presses the sealing plug downwards, the clips 608 of the bracket 602 are more evenly stressed.

In this embodiment, the connecting beam 621 is generally maintained in the shape of an I-shaped crossbeam. The width of the connecting beam 621 on the left side of the positioning hole 722 is greater than the width of the connecting beam 621 on the right side of the positioning hole 722, such that two clips 608 can be provided at a circumferential edge of the connecting beam 621 on the left side, and one clip 608 can be provided at the circumferential edge of the connecting beam 621 on the right side. The three clips 608 are in a generally isosceles triangle arrangement. Compared with the connecting beam 621 that includes three crossbeams in a “Y”-shaped arrangement, the arrangement in this embodiment in which two clips 608 are disposed on one side of the connecting beam 621 and another one clip 608 is disposed on the other side of the connecting beam 621 can reduce the size of the connecting beam 621 while ensuring that the three clips 608 are disposed around the axis x, thereby reducing the material consumption.

In an existing sealing plug, a sealant is generally applied to the outside of a sealing cover made of metal, and the sealing cover and the sealant are snap-fitted together by using a structure such as a mounting groove. Resilient legs are deformably connected to the bottom of the sealing cover to connect the sealing plug to the component to be sealed. For some vertical components to be sealed that require sealing, after the sealing plug is inserted into a hole of the component to be sealed, the sealant of the sealing plug may sag during a heating process, which not only affects the appearance, but also may cause the sealant to be unevenly distributed to affect the sealing effect of the sealing plug.

In the sealing plug of the present disclosure, the sealing cover and the bracket are two separate parts, and are then connected together by a connection process such as riveting, and the sealant can be sandwiched between the sealing cover and the bracket. In the sealing plug, the sealing cover is provided with the receiving space, and the sealant is received in the receiving space, such that the sealing cover and the bracket restrict the flow of the sealant when the sealant melts, thus avoiding sagging of the sealant after melting or unevenness of the sealant after curing, which not only does not affect the appearance of the component to be sealed, but also ensures the reliability of the sealing plug for sealing the hole of the component to be sealed.

In addition, in the sealing plug of the present disclosure, it is only necessary to connect the sealing cover and the bracket both made of metal, which avoids the connection between the sealant that is soft and a metal part, thereby reducing the assembly difficulty of the sealant.

Furthermore, since the bracket can be manufactured separately, the resilient leg may be independently configured to have a structure that can be easily deformed and does not have excessive insertion force, and thus may not limited by the structure of the sealing cover.

Although the present disclosure is described with reference to the examples of embodiments outlined above, various alternatives, modifications, variations, improvements and/or substantial equivalents, which are known or anticipated at present or to be anticipated before long, may be obvious to those of at least ordinary skill in the art. In addition, the technical effects and/or technical problems described in this specification are exemplary rather than limiting; Therefore, the disclosure in this specification may be used to solve other technical problems and have other technical effects and/or may solve other technical problems. Accordingly, the examples of the embodiments of the present disclosure as set forth above are intended to be illustrative rather than limiting. Various changes may be made without departing from the spirit or scope of the present disclosure. Therefore, the present disclosure is intended to embrace all known or earlier disclosed alternatives, modifications, variations, improvements and/or substantial equivalents.

What is claimed is:

1. A sealing plug for sealing a hole of a component to be sealed, the sealing plug comprising:
a sealing cover configured to cover the hole of the component to be sealed, the sealing cover having at least one receiving space;
a sealant disposed around the hole of the component to be sealed, the sealant being at least partially received in the at least one receiving space; and
a bracket connected to the sealing cover;
wherein the sealing cover and the bracket are configured such that when the sealant melts, the sealing cover and the bracket at least partially restrict flow of the sealant.

2. The sealing plug according to claim 1, wherein
the at least one receiving space comprises a receiving groove, wherein the receiving groove extends from a bottom of the sealing cover towards a top of the sealing cover, the receiving groove forms a bottom opening at the bottom of the sealing cover, and the sealant is at least partially received in the receiving groove through the bottom opening; and
the bracket is connected below the sealing cover and at least partially shields the bottom opening, such that the sealant is sandwiched between the sealing cover and the bracket.

3. The sealing plug according to claim 2, wherein
the sealing plug has an axis (x), the receiving groove extending from the bottom of the sealing cover towards the top of the sealing cover in the direction of the axis (x), and the receiving groove and the sealant is ring-shaped extending around the axis (x).

4. The sealing plug according to claim 3, wherein
the sealant comprises:
a sealing top portion received in the receiving groove; and
a sealing bottom portion connected to the sealing top portion, the sealing bottom portion being disposed around the hole of the component to be sealed.

5. The sealing plug according to claim 4, wherein
the sealing cover comprises:
a sealing lip; and
an arched portion arching upwards relative to the sealing lip, the sealing lip being disposed around the arched portion and at a periphery of the arched portion, and the receiving groove being disposed in the arched portion; and
the sealing bottom portion is connected below the sealing lip, and is configured to abut against the component to be sealed.

6. The sealing plug according to claim 5, wherein
the sealing cover further comprises a cover body, the arched portion being disposed around the cover body and between the cover body and the sealing lip, and the bracket being connected to the cover body.

7. The sealing plug according to claim 4, wherein
the sealant comprises a sealant body, wherein the sealing top portion extends inwards from a top of the sealant body, and the sealing bottom portion extends outwards from a bottom of the sealant body.

8. The sealing plug according to claim 2, wherein
the bracket is configured such that when the sealing plug seals the hole of the component to be sealed, the bracket is snap-fitted with a hole edge of the hole of the component to be sealed to retain the sealing plug in the component to be sealed.

9. The sealing plug according to claim 8, wherein
the bracket comprises at least two clips, wherein each of the at least two clips extends downwards from an edge of the bracket, and each clip comprises a resilient leg configured to be resiliently deflected to abut against the hole edge of the hole to retain the sealing plug in the component to be sealed.

10. The sealing plug according to claim 9, wherein
each clip has a window;
the resilient leg comprises an upper leg portion, a bent portion and a lower leg portion, the bent portion being connected between the upper leg portion and the lower leg portion, the upper leg portion extending obliquely outwards from a top end of the upper leg portion to the bent portion, and the lower leg portion extending obliquely inwards from the bent portion to a bottom end of the lower leg portion; and
the bottom end of the lower leg portion is connected to an edge of the window, and the top end of the upper leg portion forms a free end.

11. The sealing plug according to claim 10, wherein
the resilient leg further comprises a top portion, wherein the top portion is connected to a top of the upper leg portion, and the top portion is disposed at an inner side of the sealing bottom portion of the sealant.

12. The sealing plug according to claim 1, wherein
the sealing cover and the bracket are made of metal material, and the sealant is made of hot melt adhesive.
